(19) United States
(12) Patent Application Publication
(10) Pub. No.: US 2026/0274254 A1
(43) Pub. Date: Sep. 17, 2026

(54) SYSTEM AND METHOD FOR REGULATING OPERATIONAL PARAMETERS OF LOW-SPEED VEHICLES

(71) Applicant: Gabriel Alejandro Reberte, Deerfield Beach, FL (US)

(72) Inventor: Gabriel Alejandro Reberte, Deerfield Beach, FL (US)

(21) Appl. No.: 19/080,353

(22) Filed: Mar. 14, 2025

(51) Int. Cl. B60W 30/14; B60W 30/182; B60W 50/08; H04L 12/40; H04W 4/40; H04W 4/80

(52) U.S. Cl. CPC B60W 30/143; B60W 30/182; B60W 50/082; H04L 12/40; H04W 4/40; H04W 4/80; B60W 2510/0657; B60W 2540/215; B60W 2556/45; H04L 2012/40215; H04L 2012/40273

(57) ABSTRACT

A low-speed vehicle governor regulator includes a circuit board mounted within a housing, with a microprocessor and a microcontroller mounted on the circuit board. The microprocessor includes a first connector couples to a vehicle control module. The microcontroller includes a second connector couples to a speed controller. The microcontroller is electrically connected to the microprocessor. The microprocessor intercepts and replaces signals emitted by the vehicle control module and the microcontroller instructs the speed controller to change locally stored revolutions per minute parameters.

### BACKGROUND OF THE INVENTION

The present invention relates to low-speed vehicles and, more particularly, to electric vehicle controllers and regulators.

Global Electric Motorcars™ (GEM) and Moke™ cars are classified as Low-Speed Vehicles (LSVs). LSVs are special purpose low speed vehicles. Often LSVs are used as recreational or work vehicles on golf courses, farms, ranches, apartment communities, resort style communities, theme parks, university campuses, etc. They are set by the manufacturer or distributor to have a set maximum speed of between 20 MPH to 35 MPH. LSVs have requirements and restrictions on use that are unique to this class of vehicle. Situations may arise where an owner may want to regulate an LSV's operational speed. Depending on regulations, maximum speed, and intended use, LSVs can be restricted to being driven on certain roads and highways and require registration to operate.

As can be seen, there is a need for a means to regulate an LSV's operational speed.

### SUMMARY OF THE INVENTION

In one aspect of the present invention, a low-speed vehicle governor regulator comprises a housing; a circuit board mounted within the housing; a microprocessor mounted on the circuit board, wherein the microprocessor includes a first connector couplable to a vehicle control module; and a microcontroller mounted on the circuit board and electrically connected to the microprocessor, wherein the microcontroller includes a second connector couplable to a speed controller. The microprocessor is operative to intercept and replace signals emitted by the vehicle control module and the microcontroller is operative to instruct the speed controller to change locally stored revolutions per minute parameters.

These and other features, aspects and advantages of the present invention will become better understood with reference to the following drawings, description, and claims.

### BRIEF DESCRIPTION OF THE DRAWINGS

FIG. 1 is a schematic view of a speed controller according to an embodiment of the present invention;

FIG. 2 is an exploded schematic view thereof; and

FIG. 3 is a flow chart of a method of using the speed controller, according to another embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is an LSV regulator that lets an owner of a LSV vehicle regulate the speed limit of the vehicle via Bluetooth®. The regulator, sometimes referred to herein as “SpeedBX”, generally comprises a microprocessor and a system-on-a-chip microcontroller.

As used herein, the term “low-speed vehicle” refers to a vehicle with a maximum speed limited, for example, to 25 miles per hour (MPH) as manufactured. The “SpeedBX” regulator of the present subject matter may increase or decrease the maximum speed, for example up to about 35 MPH or down to about 15 MPH.

Vital functions of a car, like throttle and directional switch, are wired to a vehicle control module (VCM). Polaris® GEM, now Waev™, uses a Bosch® ME17.9.74 as a VCM. The VCM sends RPM and Max RPM torque requests to a SEVCON™ speed controller via a Controller Area Network (CANbus).

Any microprocessor operative to manipulate bytes of CAN ID 0xcFF1300, such as Teensy®, may be used in the inventive regulator. The Teensy® 4.0 Development Board acts as a programmable “CANBridge” operative to intercept and replace CANbus messages coming from the LSV's control module, controlling parameters including MAX RPM data in real time. Teensy® is connected to a dual CAN, referred to herein as CAN1 and CAN2. Teensy® specifically grabs Bytes from the CANBUS chip 3 and replaces them with FF (the maximum allowed number in hexadecimal). All other signals are untouched, including the ones coming from the SEVCON™ speed controller (aka heartbeats).
CAN1 is connected to the vehicle control module.
CAN2 is connected to the speed controller. Teensy® grabs bytes 3 and 4 of the CAN ID 0xCFF1300 and replaces them with 0xff. That way, the speed controller sees “unlimited rpm”. Teensy® and ESP32® work together.

ESP32® (a low-cost, low-power system on a chip (SoC) series with Wi-Fi & dual-mode Bluetooth® capabilities) connects a cellphone app via Bluetooth® to the SEVCON™ speed controller via CAN2. ESP32® sends Controller Area Network (CAN) messages selected in an iOS® or Android® app to change local parameters that are stored inside the SEVCON™. For example, it sends data to the speed controller to change maximum revolutions per minute (RPM) and torque maps and to set up local RPM limits (e.g., economy (ECO), Normal, or Sport).

CANmodule MCP2515 chips (a stand-alone CAN controller that implements the CAN specification, Version 2.0B) and voltage regulators that convert 24 VDC from Sevcon™ to 5V to power Teensy® and 3.3V to power ESP 32® may also be used.

In some embodiments, a secondary MCP2515 chip from ESP32® may be connected to the VCM side of the CAN network for future “over-the-air” updates.

In some embodiments, Long-term evolution (LTE) and Global Positioning System (GPS) features may be provided to broadcast useful information to the application (APP).

To connect SpeedBX to the Sevcon® Speed controller, the user may unplug the existing AMPSEAL® 35 pin electrical connector from a vehicle's Sevcon® speed controller. The user may then plug the speed controller into the SpeedBX regulator with an AMPSEAL® 35 pin Female connector. The regulator may be powered by connecting a ring terminal to B-(battery negative).

To use the regulator, the user may download a regulator App onto a device and turn the ignition to the ON position. Using a Magnifier icon, e.g., on the bottom right corner, the user may press “Connect”. The user may then select a mode from Economy (ECO), Normal, and Sport.

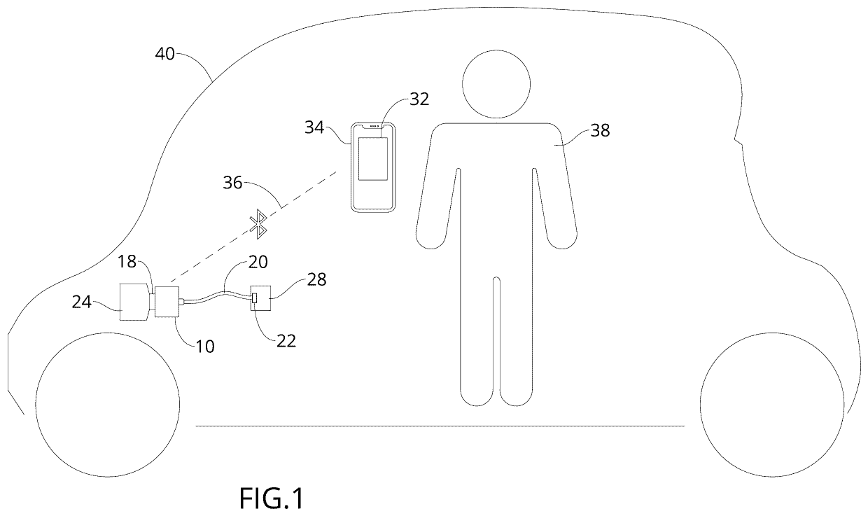

Referring to FIGS. 1-3, FIG. 1-2 illustrate a bridge housing 10 connected to a vehicle's 40 vehicle control module 24 plug 26 by a CANbus adaptor 18 and the vehicle's 40 speed controller 28 plug 30 by way of wiring 20 with a wire harness/plug 22. The bridge 10 communicates with an application 32 on a user's 38 mobile device 34 wirelessly via a Bluetooth® signal 36.

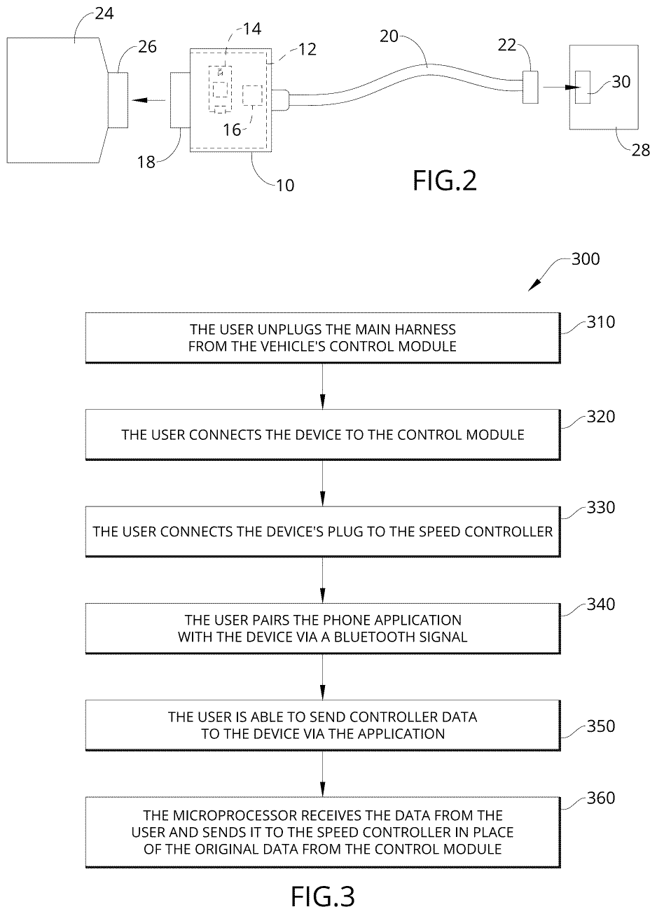

As shown in FIG. 2, the bridge housing 10 contains a microprocessor 14 and a Bluetooth® receiver 16 mounted on a circuit board 12.

A method 300 of using the bridge 10 is disclosed in FIG. 3. unplugs 310, connects 320, connects 330, pairs 340, sends 350, receives and transmits 360

It should be understood, of course, that the foregoing relates to exemplary embodiments of the invention and that modifications may be made without departing from the spirit and scope of the invention as set forth in the following claims.

What is claimed is:

1. A low-speed vehicle governor regulator, comprising:
a) a housing;
b) a circuit board mounted within the housing;
c) a microprocessor mounted on the circuit board, wherein the microprocessor includes a first connector couplable to a vehicle control module; and
d) a microcontroller mounted on the circuit board and electrically connected to the microprocessor, wherein the microcontroller includes a second connector couplable to a speed controller;
wherein the microprocessor is operative to intercept and replace signals emitted by the vehicle control module and the microcontroller is operative to instruct the speed controller to change locally stored revolutions per minute parameters.

2. The low-speed vehicle governor regulator of claim 1, wherein the microprocessor grabs bytes 3 and 4 of the CAN ID 0xCFF1300.

3. The low-speed vehicle governor regulator of claim 1, wherein the microcontroller is further operative to transmit torque maps to the speed controller.

4. The low-speed vehicle governor regulator of claim 1, wherein the microcontroller transmits the hexadecimal value FF to the speed controller.

5. The low-speed vehicle governor regulator of claim 1, wherein the first connector is a 35-pin electrical connector.

6. The low-speed vehicle governor regulator of claim 1, wherein the second connector is a 35-pin electrical connector.

7. The low-speed vehicle governor regulator of claim 1, further comprising a terminal extending from the housing, wherein the terminal is couplable to a vehicle battery and is electrically connected to the microprocessor and the microcontroller.

8. The low-speed vehicle governor regulator of claim 1, wherein the microcontroller further comprises a wireless transmitter and receiver operative to communicate with a smartphone application.

9. The low-speed vehicle governor regulator of claim 8, wherein the smartphone application enables selection of a mode selected from the group consisting of economy, normal, and sport.
